(19) United States
(12) Patent Application Publication
(10) Pub. No.: US 2007/0155360 A1
(43) Pub. Date: Jul. 5, 2007

(54) Methods, Apparatuses and Systems for the Reporting of Roadway Speed and Incident Data and the Constructing of Speed Map Database

(76) Inventor: Yafan An, Fremont, CA (US)

Correspondence Address: YAFAN AN, 40414 LA JOLLA CT., FREMONT, CA, 94539, US

(21) Appl. No.: 11/618,027

(22) Filed: Dec. 29, 2006

Related U.S. Application Data
(60) Provisional application No. 60/766,043, filed on Dec. 30, 2005.

(51) Int. Cl. H04Q 7/20

(52) U.S. Cl. 455/403; 455/426.2

(57) ABSTRACT

A method and architecture for constructing, updating, and maintaining a map database extended with real-time roadway speed data is described. The method and system include a plurality of mobile reporting devices, communication channels, and servers that receive the speed and incident reports and maintain an extended map database. The extended map database is a spatial database with extended speed attributes. The reporting devices or the server use map-assisted filtering and gyro history comparison to ensure a reported speed is snapped to a valid road segment and with sufficient accuracy.

This application claims benefit of provisional application 66/766043 filed on Dec. 30, 2005.

### FIELD OF INVENTION

The present invention relates to personal real-time traffic and navigational services. More specifically, the current invention relates to the methods, apparatuses, and systems for gathering, reporting, processing, and utilizing of roadway speed, travel time, and roadway incident data for informational, navigational and other services. Even more specifically, this invention relates to the use of communication systems for gathering, filtering, reporting, and processing these data into a usable form.

### BACKGROUND OF INVENTION

Telematics refers to the integrated use of telecommunications and informatics, also known as ICT (Information and Communications Technology). It is the science, technology, systems, and services of sending, receiving and storing of information via telecommunication devices. It generally involves a wireless communications system for the collection and dissemination of information, particularly refers to vehicle-based electronic systems, vehicle tracking and positioning, on-line vehicle navigation and information systems and emergency assistance.

The effective utilization of roadway speed and travel time for general navigational and informational services is an emerging field of commercial application. A prominent method is by using conductor loops, as briefly described in [Para 33].

Location estimation (or fixing) is a related sub-field. Location fixing is about deriving the location information of certain objects/devices. There are generally two methods for deriving the position of an object's location:
1. Global Positioning System (GPS)-based location fixing—the use of multiple global positioning satellites. An object with a GPS signal receiver processes received signals from multiple satellites and hence derive its location;
2. Cellular phone-based location fixing—the use of cellular phone's transmitted radio signals received at multiple Base Transceiver Stations (BTS). The characteristics (such as timing difference) of received cell phone signals at multiple BTS are processed using a form of triangulation to derive an estimate of the cellular phone's location. In certain embodiments, cell phone's assistance is utilized in deriving its location.

The above fields have traditionally been dealt with in an isolated, un-integrated, or loosely-integrated fashion, despite the close relationship among them. Due to the isolation of individual techniques, methods, and apparatuses, these fields are not producing enough benefits in deriving roadway speed map for commercial utilization.

Speed estimation is usually based on location fixing. However, location fixing does not deal with providing speed estimation, nor does it construct a speed map for commercial usage. The current location fixing techniques, in its isolated form, do not satisfy the requirement for reliable roadway speed estimation due to the following reasons:
The accuracy of certain location fixing techniques do not lead to enough accuracy for speed estimation;
Spurious estimations of speed significantly degrade the accuracy of roadway speed estimates to an unusable level. One example of this is that location fixing disregard or unable to identify whether a device is on or off a roadway, or whether it is carried by a walking person or inside a vehicle.

Speed estimation and the construction of speed map involve various other techniques beyond location fixing. The current invention provides an integrated method of deriving, reporting, filtering, and processing of location, speed, and route data for personal traffic and navigational services.

### SUMMARY OF INVENTION

A method and apparatus (or server machine) in a communication network, which receives, aggregates, and processes reported roadway location, speed, and short history of these data, and the method of processing these data and constructing a roadway speed map, are described. In particular, the utilization of a short speed and location history and the gyro comparison algorithm as a filtering mechanism to derive accurate estimate of roadway speed for the appropriate road segments, is described.

Methods and apparatus of mobile device or equipment (referred to as mobile reporting device later in this disclosure), standalone or integrated with a vehicle, which participate in the measurement and reporting of location, speed, and road segment id to the above server, are described.

A cost-effective method and reporting channel utilizing wireless wide area network (WWAN), such as the cellular, WiMax or other radio networks, is described, for communicating the location, speed, and road segment data from the mobile reporting devices to the server. In one embodiment, the use of cellular network's data channel and/or Short Message Service (SMS) is described.

According to one aspect of the method and the above server, the roadway speed are processed, combined, integrated, and associated (collectively called association) with a map database, external or internal to the speed database, to form a roadway speed map database, which is an representation of map and routes enriched with close-to real-time roadway speed data. In one embodiment of this association, an extended map storage format, and the spatial and temporal indexing of map data element, necessary for efficient searching, is described.

According to one other aspect of the method and the above server, a storage format for extended map database is described. Such format facilitates the effective searching, estimating, retrieving, transmission, and presentation of travel time on designated routes.

According to one other aspect of the method and the above server, a roadway speed map enriched with vehicle density data is dynamically estimated from the reported location, speed, and road-segment data from the reporting devices. This aspect of the method specifies the means for determining the frequency of reporting, and the weight assigned to individual reports for constructing the roadway speed map.

According to one other aspect of the methods and the above reporting device, GPS receiver and WWAN transceiver are coordinated, connected, or integrated to form a reporting system or device for deriving and reporting of speed and location. Several different embodiments of the reporting device are described.

According to one other aspect of the method and the above reporting device, the map-assisted method of qualifying, filtering, and modifying the estimated location, speed, and history data, is described. Such method improves the quality of roadway speed information for commercial use.

Definition List 1

| Term | Definition |
|---|---|
| Server | See [Para 8] |
| Reporting Device | See [Para 9] |
| Reporting Channel | See [Para 10] |
| Association | See [Para 11]. A process for associating |
| | the reported data with the map database |
| Extended Map Storage | See [Para 12]. A format for storing and |
| | associating speed and time info for |
| | effective search. |
| Vehicle Density | [Para 13]. The representation of the |
| | number of vehicles on a route segment |
| | in a quantifiable fashion. |
| Map-assisted Reporting | [Para 15]. Reports are pre-processed |
| | according to available map data. |

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of one embodiment of network architecture; where reporting devices, with or without vehicles, deriving location, speed, and optionally, road-segment ID, based on received satellite signals or other means of location determination, and send these data to a server via wireless WAN. The server provides speed data, and optimally, map enriched with speed data via a downlink channel for traffic, informational and/or navigational services.

FIG. 2 is a block diagram of one embodiment of a reporting device; where the device has both a GPS radio receiver and a WWAN transceiver. This embodiment depicts and device with integrated GPS navigation modules (as seen in common GPS navigators), a WWAN transceiver module (as seen in common cellular phones), and augmented with the teachings of this invention. The Reporting Module utilizes map-assisted filtering technique to produce quality roadway speed report to the server via the reporting channel. This embodiment also includes an optional real-time Route Speed Update module which may request, receive, store and present the interested routes with speed data for traffic and/or navigational services.

FIG. 3 is a block diagram of another embodiment of a reporting device. Compared to the previous embodiment, this reporting system contains multiple devices. In this embodiment, it contains a GPS navigation device (such as a car-installed or portable GPS navigator device) and a WWAN transceiver device (such as a cell phone or a personal wireless communication device). The two devices are paired or connected via a short range wireless or wired transmission channels (such as Bluetooth, Wifi or USB etc.). The Reporting Module utilizes map-assisted filtering technique to produce quality roadway speed report to the server via the reporting channel. This embodiment also includes an optional real-time Route Speed Update module which may request, receive, store and present the interested routes with speed data for traffic and/or navigational services.

FIG. 4 show two more embodiments of the reporting device. Compared to the previous embodiments, these two embodiments do not contain an extensive map database. In these embodiments, the device may not have enough memory or processing power to store an extended map database or perform intensive processing. FIG. 4A depicts a smart phone or Personal Digital Assistant (PDA) phone with a GPS receiver. FIG. 4B depicts a smart phone without a GPS receiver. Both embodiments are augmented with software programs according to the teachings of this invention. An embodiment with a GPS receiver (or any other means of location determination) can be augmented as depicted in FIG. 4A to become a reporting device. An embodiment without any location determination means can be augmented as depicted in FIG. 4B to become a traffic receiver. It is also common that such embodiments may support the storing of limited map data, such as map of particular route or area.

FIG. 5 is a block diagram of a GPS receiver module according to prior art. As can be seen, this embodiment does not include a module to derive and report reliable roadway speed.

FIG. 6 is another block diagram of a GPS receiver module according to prior art. As can be seen, this embodiment does not include a module to derive, filter, and report reliable roadway speed data.

FIG. 7 shows a map with part of a route. This figure will be used to illustrate the Gyro Comparison algorithm later in this disclosure. A part of a route is divided into pieces according to a quantization scheme. Each piece of a route is represented by a straight segment. The arrow of a segment depicts the heading (or angle) of the segment. A route can be quantized by the distance on the route or the time used to travel on that part of the route with certain speed.

FIG. 8 shows a function Y=f(X) of the quantized route. This figure will be used to illustrate the Gyro Comparison algorithm later in this disclosure. In FIG. 8, the Y value is the difference of headings (or angle) between consecutive segments.

FIG. 9 shows a simplified operation of the Gyro Comparison algorithm. FIG. 9A shows a function Y′=f(X′) of traveled route by a reporting device. X′ is quantized in a similar fashion of X in FIG. 8. FIG. 9B show the correlation of Y and Y′, where the correlation has the highest value when X and X′ are matched.

### DETAILED DESCRIPTION OF THE INVENTION

In the following description, numerous details are set forth. It will be apparent, however, to one skilled in the art, that the present invention may be practiced without these specific details. In other instances, well-known structures, procedures, and devices are shown in block diagrams, brief introductions, or pictures, rather than in detail, in order to avoid obscuring the present invention.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “estimating” or “computing” or “calculating” or “deriving” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. The apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, hard disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

The Method and Architecture

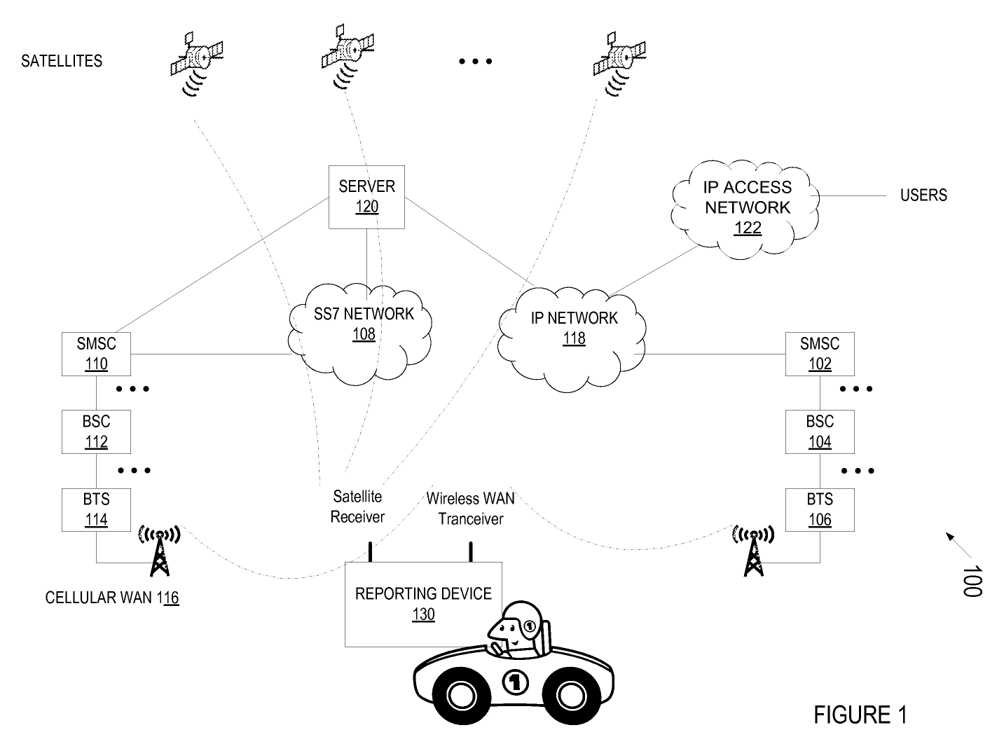

FIG. 1 is a block diagram of one embodiment of network architecture for utilizing the method. The mobile reporting device derives location, speed and current road segment information, executes a filtering policy, and reports this information to the server. The reporting channel (or uplink) is through the wireless WAN network.

The method or architecture is more fully understood when the various components of the architecture are described, although those should not be taken to limit the invention to only the specific components only.

Prior Art 1: Conductor Loops

Prior ways of obtaining roadway speed data is by placing conductor loops at certain spacing on the roadways. The vehicles pass the loops and the speed is measured. Electrical circuits and apparatus are deployed along with the conductor loops to perform measuring. The circuits or apparatus are powered, sometimes and where needed, by solar energy converters. The apparatus transmit the speed data to a centralized server.

This method is costly due to the fact that it is costly to place many loops on every roadway segments and to supply power to the circuit at the site of the loops, and build a transmission channel to transmit the speed data to a centralized server.

Relevant Prior Art 2: Cell Phone Signal Triangulation

The method of location fixing by analyzing the signal arrival time differences and arrival angles of cellular phones' communication signals. In certain embodiments of the method, radio signal measurement is done at the cellular network's Base Transceiver Station (BTS), with or without measurement at the mobile phones. The cell phone's location is calculated by a form of mathematical triangulation based on known locations of the BTS'.

This prior art is about deriving location coordinates of a cell phone. It falls short to provide roadway speed estimation.

This method is costly to implement since it may require many cellular base stations to be modified or augmented to measure the signals. This solution relies on signals transmitted from the mobile station (MS) to multiple fixed base stations (BTS). The systems suffer from multi-path, diffraction, weak signal conditions and poor cell site geometry that lead to decreased accuracy and availability. Also the method renders it impractical to reliably filter valid measurements from invalid, inaccurate measurement and to distinguish cell phones on a roadway from those which are not. After all, the measurement result is not accurate enough to produce reliable roadway speed estimation for commercial use.

Relevant Prior Art 3: Non-Assisted GPS and Assisted GPS

This prior art is about deriving location coordinates of a cell phone.

Cell phones with a GPS receiver typically rely on Global Positioning System (GPS) capabilities. The GPS receiver references a constellation of 24 GPS satellites that circle the earth every 12 hours.

GPS-only solutions are computation intensive and relatively slow to provide a fix. This situation is aggravated on a cell-phone due to its limited computation and storage capacity.

Assisted GPS reduces the computation requirements on a cell-phone by using a network server to provide a cell-phone with partial pre-computed data, such as pre-selected satellites and preliminary timing information. By combining the two information sources, the handset is able to produce a position fix in a matter of seconds, instead of minutes.

However, such solution still lacks the means to qualify, derive, filter, and report the roadway speed data. Some of the limitations include: a cell-phone is not powerful enough to store large and detailed maps for effective filtering; and it is restricted by battery energy from sustained processing and reporting of speed data.

The Reporting Device and the Client Device

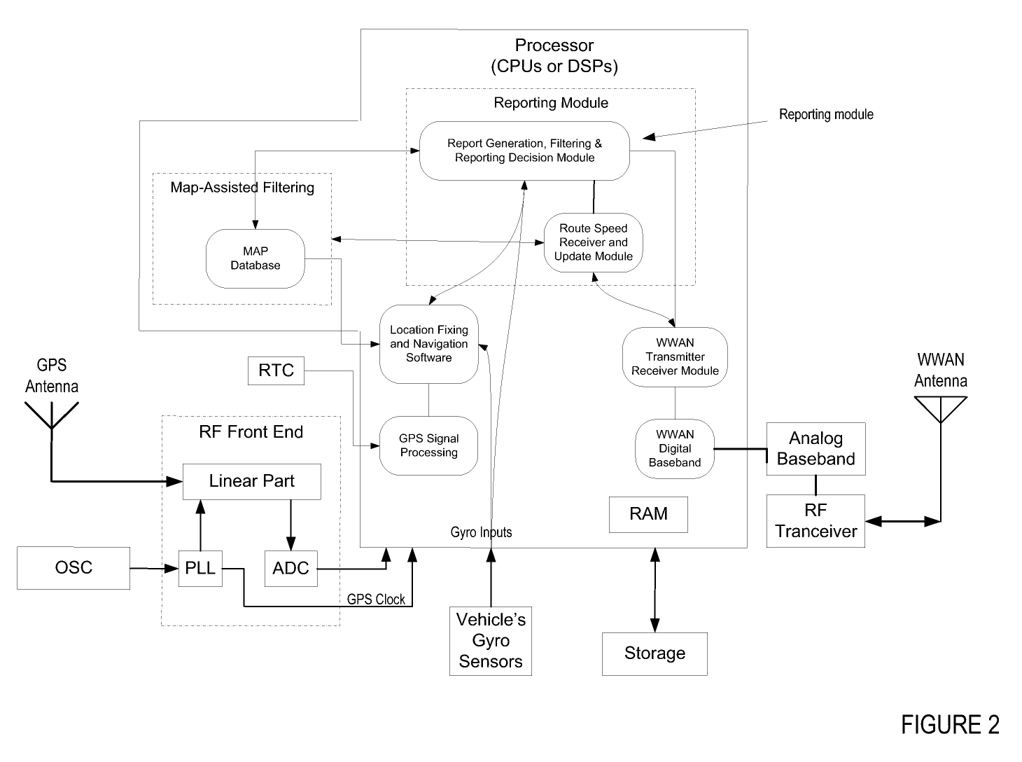

FIG. 2 is a block diagram of one embodiment of a reporting device. Such a device may be integrated with a vehicle or standalone but travels with a vehicle.

In this embodiment of the invention, the Map-assisted Filtering and the Reporting modules are integrated with two prior fields of arts, the GPS receiver and the WWAN transceiver, to produce a powerful roadway speed reporting device.

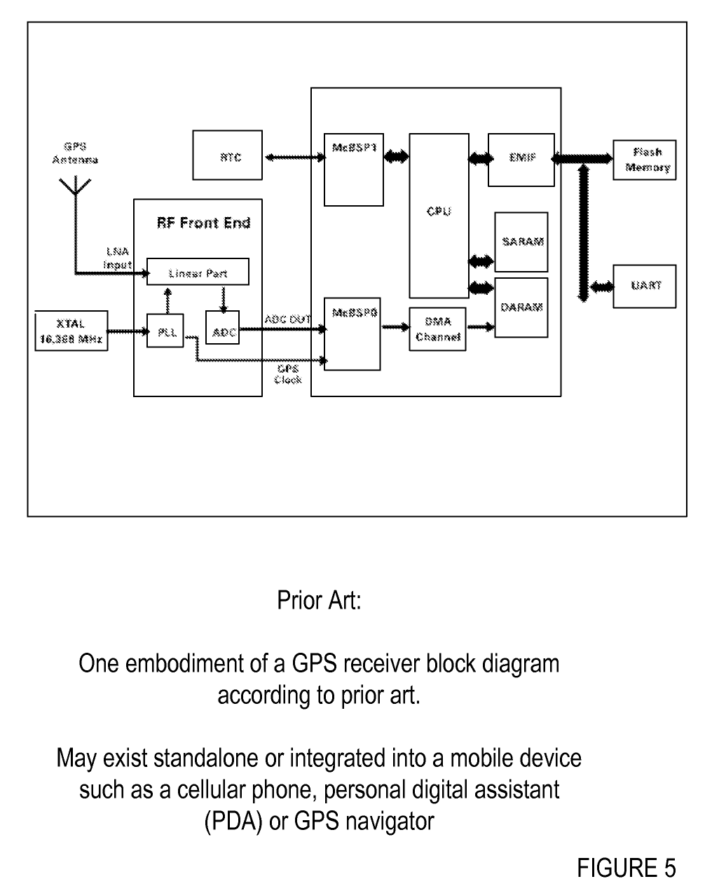

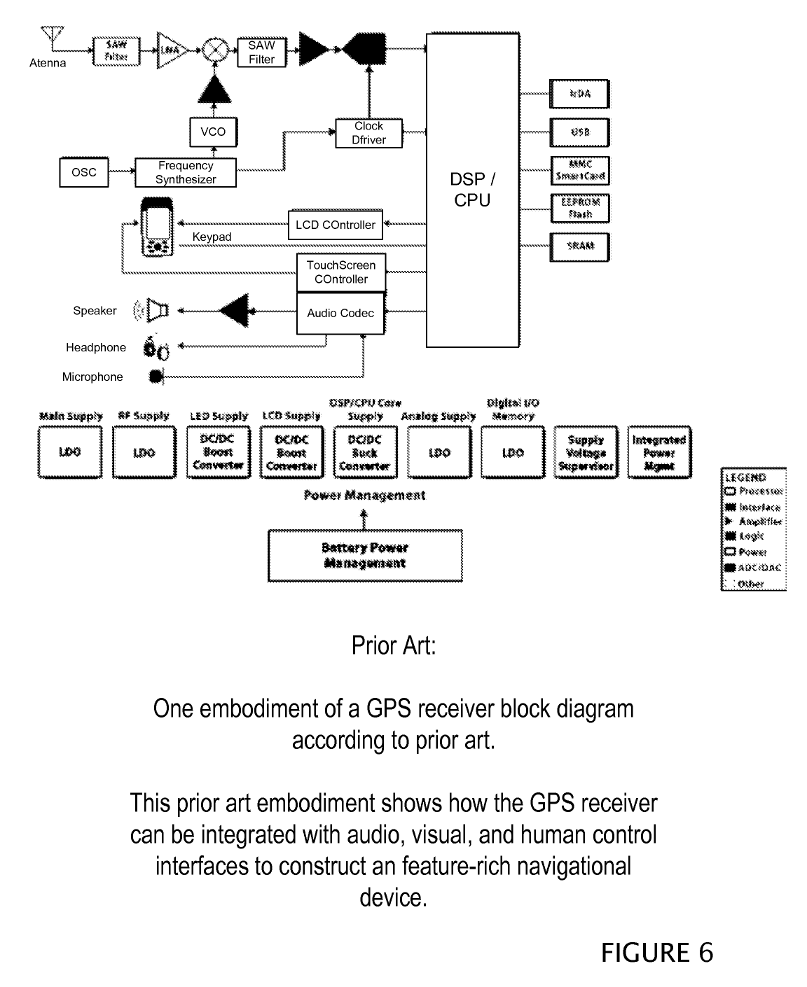

In order to simplify the description of the current invention, the prior art components are simply shown in figures:
FIG. 5 is a block diagram of one embodiment of a GPS receiver component.
FIG. 6 is a block diagram of one embodiment of a WWAN transceiver component for the construction of a cellular phone or PDA.

Referring to FIG. 2, a reporting device has a GPS radio signal receiver. The GPS works on the principle that if you know your distance from several locations, then you can calculate your location. The known locations are the 24 satellites located in six orbital planes at known altitude, say, 20,200 Km. These satellites broadcast a data stream at the primary frequency, say of 1.575 GHz, which carries the coarse-acquisition (C/A) encoded signal to the ground. The GPS receiver measures the time of arrival of the C/A code to a fraction of a millisecond, and thus determines the distance to the satellite.

The construction of a GPS receiver is a prior art. The core components of GPS receiving sub-system include:
Radio Frequency (RF) Front End: the GPS signals are received at the antenna and amplified by the Low-Noise-Amplifier (LNA). The RF front-end further filters, mixes, and amplifies (AGC) the signal down to the frequency where it is digitally sampled by an analog-to-digital converter (ADC).
Baseband Processor/CPU: the ADC samples of GPS C/A code signals are correlated by the digital signal processor (DSP) and then formulated to make range measurements to the GPS satellites.
Memory: the processor, DSP or general-purpose CPU, runs applications stored in memory. The OS is stored in non-volatile memory such as EE/FLASH/ROM. Applications may be loaded in FLASH or DRAM.
Clock: Both the RF front end and the GPS signaling processing modules require the reference of a real-time clock. Such clock inputs are derived off an oscillator (OSC) or a real-time clock (RTC) from another reference.

Referring to FIG. 2, the “Location Fixing and Navigation Software” module is built with prior art, similar to that of a commercial car-installed or portable GPS navigator. A successful “location fix” is the term used in the art referring to the successful estimation of the current location based the outputs of GPS signal processing module. In one embodiment of the current invention, this module is modified to integrate and interface with the Map-assisted Filtering capability.

The location fixes are further qualified, validated by a process called “map-matching”, performed by the Map-assisted Filtering module, in which, the module performs a series of qualification, filtering and modification procedures, as described below:
By referencing and searching the MAP database, the computed location fix is snapped onto the nearest road. In general, a successful snapping is indicated when the position fix is within 3˜8 meters of a road segment. The allowed error is usually set according to the accuracy of the GPS signaling processing process. For example, the bigger the number of satellites' signal used in the calculation the better accuracy of the position fix, and hence less error is allowed in declaring a position fix.
However, depending on the fix error and the density of the road network, a location fix may or may not snap onto the correct road segment. To further the accuracy of snapping to a road segment, the “Map-assisted Filtering” module performs a comparison of the vehicle gyro input history with the road-segment's gyro sequence (termed gyro comparison in this disclosure). Gyro comparison is a powerful means to eliminate and correct spurious snapping report and location fixes. One embodiment of a gyro comparison algorithm is further described below in [Para 57].
Snapped location fixes, after gyro comparison, are then provided as input to the Reporting module as input.
Further, the map database may be augmented by a road-segment id. Such an id is reported along with the speed history data to improve the efficiency of the server, which uses the same road-segment indexing scheme, in searching and assigning speed data to the road-segment in the speed database.
In one embodiment, a road-segment is a relatively short and straight segment connection two adjacent geometry points in the geo-coded map database. One example road-segment id is the lat-long of the two end points of the road-segment.

In one embodiment of the reporting device, a snapped location fix is time stamped. A speed estimate is simply calculated by dividing the traveled distance by the time difference between the previous and the current location fix. This way of calculating speed automatically averaged the speed on the road segment. In one other less-preferred embodiment of the reporting device, only location and timestamp are reported to the server and server performs estimation of speed.

Also referring to FIG. 2. The “Reporting” module selects location and speed estimate that is successfully snapped to a road segment, and then performs a procedure called “gyro comparison”, which is described below.

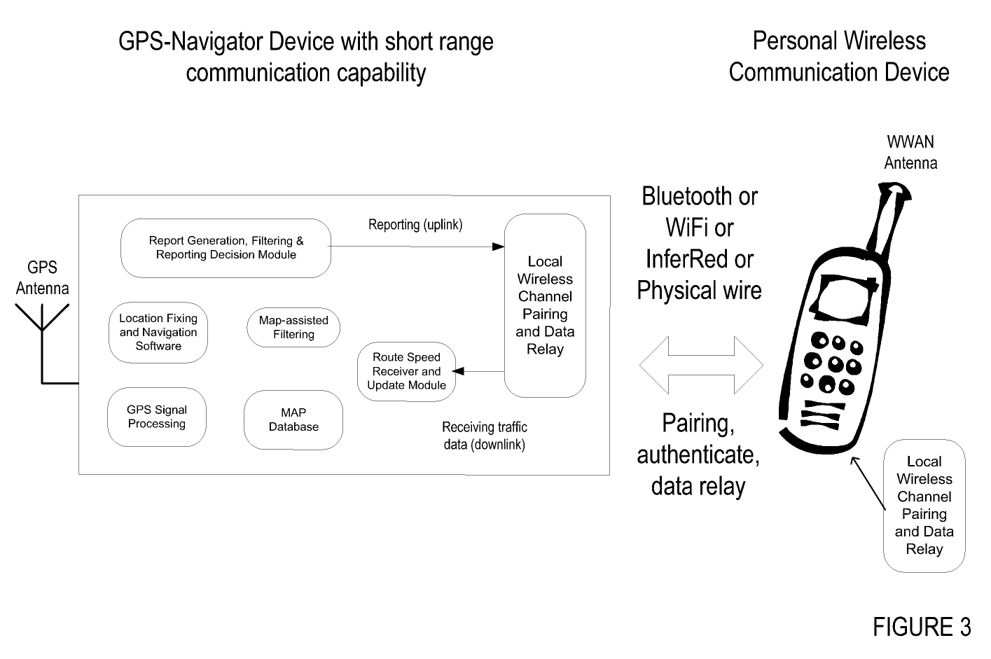

FIG. 3 shows a variation of the embodiment in FIG. 2. In this variation, the above-mentioned capabilities are implemented by the GPS-navigator device, where the WWAN link is provided by a personal wireless device such as a cellular phone, PDA, WiMax modem or other portable device. The GPS-navigator device and the personal wireless device have a short-range wireless (or wired) channel for communication, which allows the two devices to authenticate each other and establish a secure channel for the reporting of speed/location of the GPS device and receiving speed and traffic data from the server.

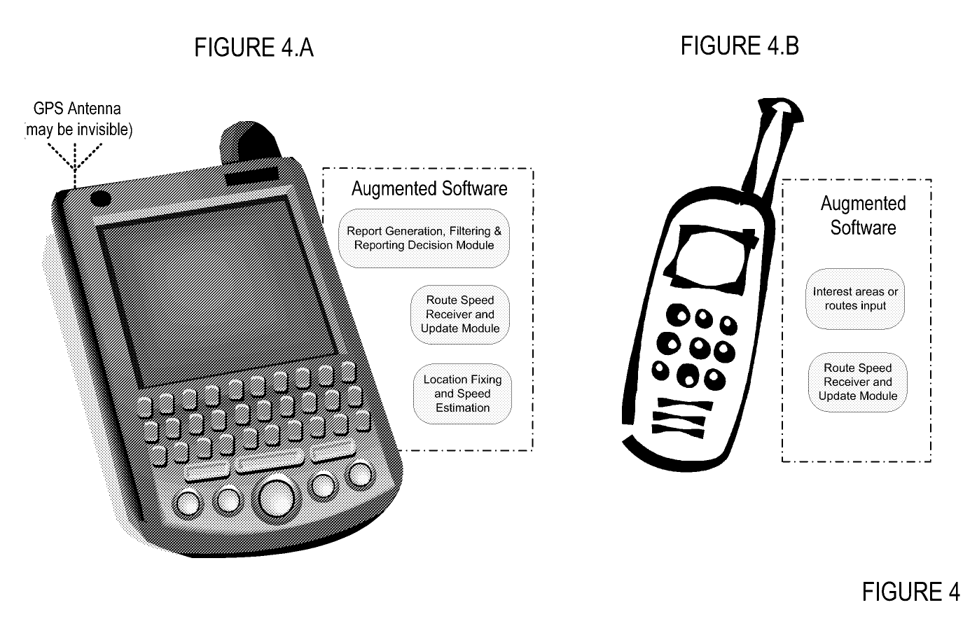

FIG. 4 shows two more variations of the embodiment in FIG. 2 with reduced capabilities, buy with wider potential use.

In FIG. 4A, the client device is a personal communication device with a GPS receiver. Yet, it may or may not have a map database. An example of such device is a cellular phone or PDA with built-in or attached GPS receiver module. This client device is then augmented with a software program implemented according to teachings of this invention which reports its location and speed history, receives speed and traffic data for designated routes, and optionally receives designated map images/data for designated areas. The client program has a user interface which utilizes received data to provide personalized traffic services for the user.

It is important to point out that the reporting of a short history of speed and location data set allows the server to perform the filtering policy by utilizing the gyro comparison algorithm.

In FIG. 4B, the client device is a personal communication device without a GPS receiver. An example of such device is a cellular phone or PDA. This client device is then augmented with a software program implemented according to teachings of this invention which receives speed and traffic data for designated routes, and optionally receives designated map images/data for designated areas. The client program has a user interface which utilizes received data to provide personalized traffic services for the user. The user interface also allows the user to specify interested area or routes.

Gyro Comparison

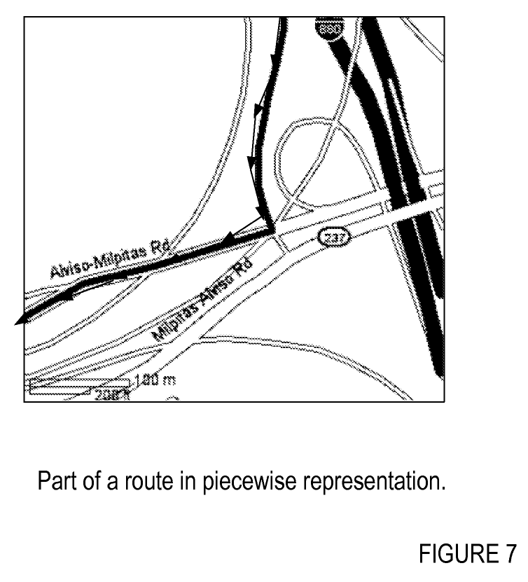

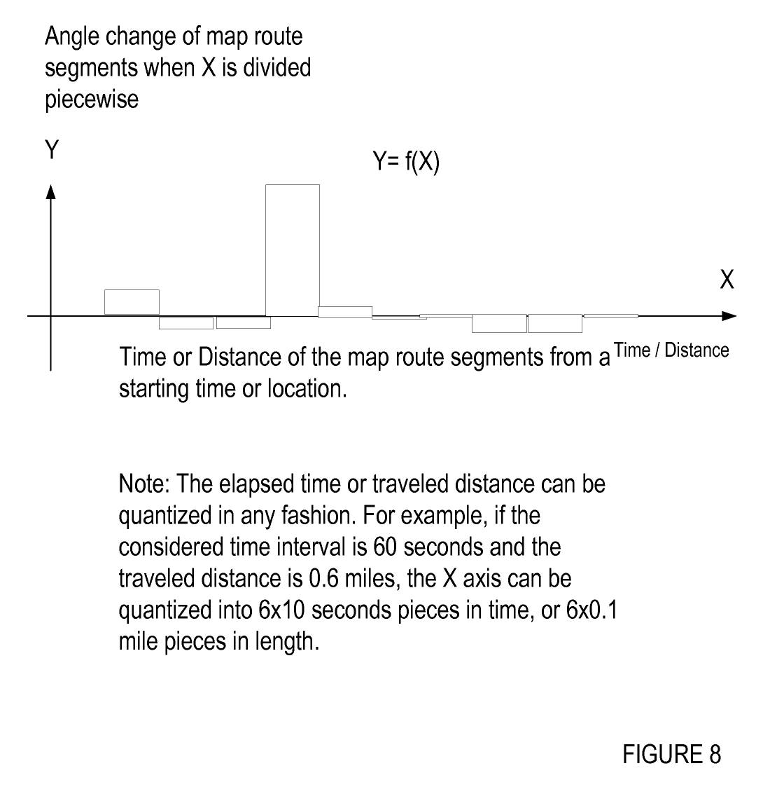

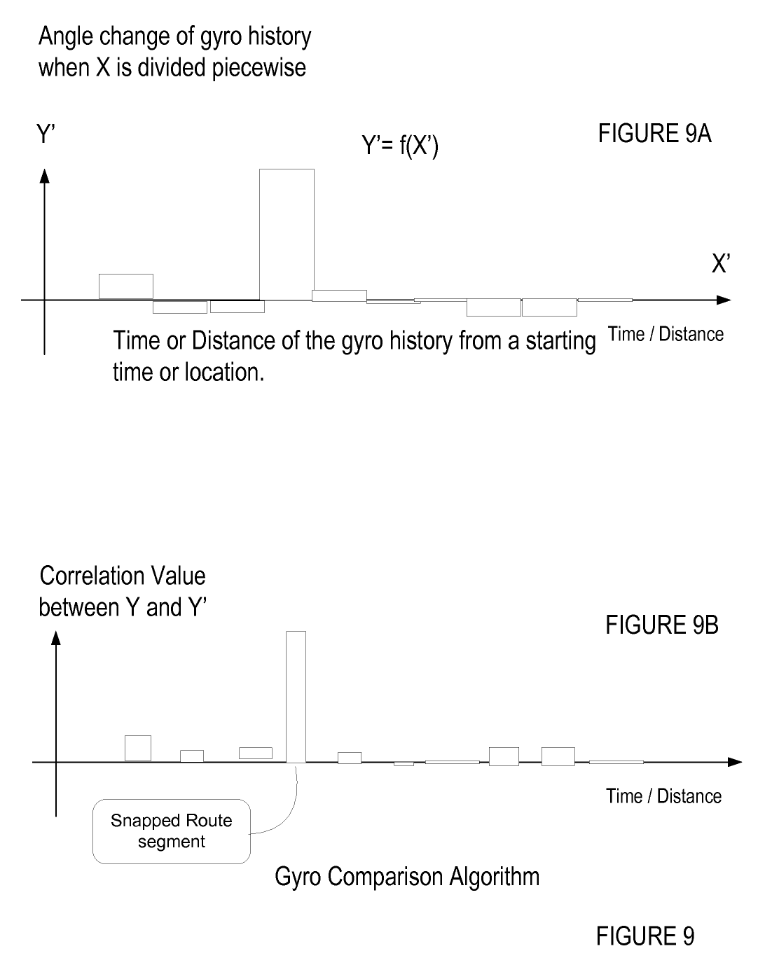

This paragraph describes one embodiment of the gyro history comparison algorithm. Gyro comparison may use classic statistical and stochastic theory or fuzzy logic algorithms. The key objective of gyro comparison is to evaluate a match between a turn-by-turn sequence measured off the gyro history of the device/vehicle's movement and the approximated turning sequence of the road segments in the map database. In one embodiment of the algorithm, it includes the following steps:
Quantized digital representation of the turn-by-turn sequence of the gyro history and the map database.
FIG. 7, 8, 9 describe one embodiment of the gyro comparison algorithm.
FIG. 7 is a piecewise representation of a sample map.
FIG. 8 is a quantized representation of a route portion on the sample map, where axis Y is the consecutive piecewise turning angle differences measured off the mapped route portion.
FIG. 9A is a quantized road segment turning sequence in consecutive piecewise turning angle differences measured off a reporting device. FIG. 9B simply shows the correlation value between the Y from map database ad the Y′ from a reporting device.
Successful gyro comparison is declared when the sequence in FIG. 8 matches the sequence in FIG. 9A, in terms of significant correlation probability or any other statistical or stochastic probability. A high probability threshold means a more stringent comparison.

In this invention, the gyro history input may be obtained via reading sensor inputs from vehicle's steering and odometer sensors, or calculated using the Reporting Device's location and orientation data history. The combination of these methods, when available, is particularly useful when GPS is unavailable on the client, or the GPS signal is temporarily blocked when a vehicle is traveling between tall buildings or inside a tunnel.

Gyro Comparison by the Server

It is greatly beneficial that a client device without a built-in database can also utilize the service. As described in [Para 54] and in FIG. 4.A, the reporting device sends a short history of location and speed, that is, a few time-stamped location and speed data set in the past few number of minutes, to the server. The server will perform map-based filtering using the gyro comparison algorithm described above.

Report Generation

The Reporting module maintains a short history of previous locations, speeds and the directions. It analyzes the history sequence, if the variation of speed, and time elapsed satisfy certain criteria, it sends a report to the server, and optionally assigns a weighting factor to the report. Note the weighting mechanism, which is a factor simply indicates the length and time it has traveled since last report, is developed to conserve network bandwidth and to accurately represent vehicle density on the road segment.

In one embodiment of the reporting criteria:
The device does not send more than 1 report within a pre-determined time interval.
The location, speed, and direction are processed via a low-pass filter. A significant change in sustained location, speed, and direction are given priority for reporting.
The weight of the report is a representation of the time elapsed since the last report, and the estimated speed or distance traveled. Such weight information is necessary for the server to accurately estimate the roadway speed and derive the vehicle density by averaging multiple reports from multiple reporting devices (or vehicles).
A report may also be augmented with additional information, such as the weighting factor, direction, the snapped road segment identifier.

It is worth noting that the procedures performed by the Map-assisted Filtering and the Reporting modules significantly improve the accuracy of reported data and to ensure their relevancy to roadway speed estimation.

Preferred Embodiments of a Reporting Device

One of the preferred embodiments of a reporting device in the current invention is a navigational device with cell-phone a transceiver that is integrated with a vehicle, implemented with the teachings of this disclosure. This reporting device can not only report roadway speed data to a server, but also request speed and traffic data for interested routes, hence provide personalized traffic and navigational services to the users.

Another preferred embodiment of a reporting device in the current invention is a car navigational unit (with a GPS receiver), which can be paired (or communicate) with a cellular phone/PDA via a wireless local area network (WLAN) transceiver, such as Wifi or Bluetooth etc. Needless to say, the WLAN link may be replaced with a wired link.

Other preferred embodiments of a reporting device in the current invention include a portable communication device with a GPS receiver and a WWAN transceiver, and a “smart phone” without a GPS receiver.

Referred to FIG. 2, FIG. 3, and FIG. 4.

The Server

An embodiment of the Server has sufficient computation power and various network interfaces or ports.

The ports are connected to the network that carries the reporting channels. For example, if SMS is used for reporting roadway speed data, a SS7 interface module supporting TCAP (transaction control application protocol) may be used; IP interface cards are used if WiMax, CDMA2000, EVDO, WCDMA, HSDPA, or WLAN networks are used for reporting speed data.

The compute modules run the programs which carry out the processing of speed reports on various road segments, and updating the speed map database.

Distributable Speed Map Storage Format

The current invention brings a brand new challenge, a speed map database storage method that is efficient enough to support thousands (or more) dynamic update operations per second. In particular, the update operations include searching, retrieving previous speed data, and updating, which make the issue significantly different than a static map storage design.

A speed map database is a multi-dimensional database, sometime also called spatial database with huge number of objects (or data elements). Prior arts have achieved significant progress in making static map database storage more suitable for efficient searching. Many of the commonly used spatial data structures rely on the concept of tile based hierarchical (or multi-tiered) trees. The current invention provides a mechanism where:
The attributes can be calculated in a multi-tiered fashion to considerably save computation cost;
A distributed computing environment where a speed map database can be partitioned according to spatial adjacency, and each partition to be processed by different physical processors;
The updated attribute values can be propagated to a central database in a transparent fashion without much additional computation cost.

In one embodiment of the invention, the speed map database is partitioned according to the number of road-segments (i.e. objects) by latitude and longitude boundaries. Then, each partition is assigned a processor module to handle search and updates related to that partition. Since the objects themselves are organized in a multi-tiered or hierarchical fashion, the processors are logically connected in a multi-tiered or hierarchical fashion. This method also includes the assignment of routable network address for each object id, which efficiently solves the message routing question.

In a related matter, each reporting device is also assigned a Server based on its location or its interested area for speed and traffic information.

The Reporting Channel

The current invention brings another brand new need, a cost-effective communication channel for reporting speed.

In one embodiment of the current invention, the Short Message Service (SMS) is used for reporting. SMS is a globally accepted wireless service that enables the transmission of alphanumeric messages between mobile subscribers and external systems such as electronic mail, paging, and voicemail systems. In this invention, the SMS is a preferred embodiment of the reporting channel, where it is used to send the report messages from the Reporting Device to the Server.

Another embodiment of the reporting channel is the wireless data channel, such as the data channel in GPRS/EDGE, 3G, or WiMax networks.

In one embodiment of the current invention, the report message is encrypted to protect privacy. The encryption algorithm itself is a prior art.

In one embodiment of the current invention, a unique tracking ID is assigned to each reporting device for a period of time and it is included in every report message.

What is claimed is:

1. A method and system architecture for the construction on a network server of an speed map database with real-time roadway speed information, where the system comprising
A plurality of personal and mobile reporting devices, car-mounted or carried by a person, measuring location and/or speed information and reporting to network server;
The use of general purpose wireless wide area network communication channels for sending speed reports and for receiving roadway speed data;
A server which receives speed reports from the said plurality of reporting devices and maintains a dynamic speed map database with close to real-time roadway speed data to serve the needs of informational, traffic, navigational and related services.

2. The method of claim 1 wherein the server receives continuous speed reports from the said plurality of reporting devices and generates and updates speed map database (that is optionally partitioned for load sharing purposes) with received roadway speed information for the affected road-segments.

3. The method of claim 1 wherein a large database is partitioned into multiple partitions according to the number of road-segments (also called objects) in a partition, and the partitions are the basis for distributing the processing load of speed reports.

4. The method of claim 1 wherein a roadway location and speed report includes a short (in the order of minutes) history of location, speed and direction data sets, and wherein the historic data is utilized by the server to qualify the report by a map-assisted filtering procedure to eliminate locations not snapped to a valid road segment.

5. The method of claim 1 wherein the reported location, speed and direction history is validated and filtered by a gyro comparison procedure.

6. A roadway speed reporting device that is implemented by augmenting a GPS navigational device and/or personal communication device, as exemplified in FIG. 2, 3, 4.A and 4.B, which measures locations (when capable), estimates speed (when capable), filters speed reports and sends speed reports to the server, and receives speed and traffic data from the server.

7. The method of claim 6 wherein a location fix produced by the GPS signal processing is further qualified by a map-assisted filtering procedure to eliminate fixes not snapped to a valid road segment.

8. The method of claim 6 wherein snapped location fixes and the snapped road segments are validated and filtered by a gyro comparison procedure.

9. Wherein claim 6 a report is further buffered and filtered when location, speed, and direction changes are not significant for reporting, for purpose of the conservation of network bandwidth and energy consumption on the device.

10. Wherein claim 6 a report include a weight factor to allow the server to derive vehicle density from received reports when aggregating reports from all reports from the same road-segments.

11. Wherein claim 6 a reporting device is a vehicle navigational system and a personal mobile device with local area wireless or wired link, and wherein both the navigational system and the mobile phone are augmented with a client software implemented according to the descriptions of this invention, and wherein the navigational system and the mobile phone can pair, connect and authenticate each other, and to relay the said speed report to the server and receive traffic data from the server.

12. Wherein claim 6 a reporting device is a personal mobile communication device with GPS receiver, and wherein the mobile communication device is augmented with a client software implemented according to the descriptions of this invention to report its location, speed, and direction to the server and receive traffic data from the server.

13. Wherein claim 6 a reporting device is a personal mobile communication device, and wherein the mobile communication device is augmented with a client software implemented according to the descriptions of this invention to request and receive traffic data from the server.
